(19) United States
(12) Patent Application Publication
(10) Pub. No.: US 2019/0018555 A1
(43) Pub. Date: Jan. 17, 2019

(54) METHOD FOR DISPLAYING MENU ON USER INTERFACE AND HANDHELD TERMINAL

(71) Applicant: HUAWEI TECHNOLOGIES CO., LTD., Shenzhen (CN)

(72) Inventors: Hao JING, Shenzhen (CN); Wenmei GAO, Beijing (CN); Chao QIN, Beijing (CN)

(73) Assignee: HUAWEI TECHNOLOGIES CO., LTD., Shenzhen (CN)

(21) Appl. No.: 16/067,128

(22) PCT Filed: Dec. 31, 2015
(86) PCT No.: PCT/CN2015/100296

§ 371 Date: Jun. 29, 2018

(51) Int. Cl. G06F 3/0482; G06F 3/0481; G06F 3/0486; G06F 3/0488

(52) U.S. Cl. CPC G06F 3/0482; G06F 3/04883; G06F 3/0486; G06F 3/04817

(57) ABSTRACT

The present invention discloses a method for displaying a menu on a user interface and a handheld terminal. The method includes: when a handheld terminal detects, in a full-screen immersive mode, a first touch operation that meets a first preset condition, obtaining a to-be-displayed overlay interface of an application program corresponding to the full-screen immersive mode, and determining controls on the interface and a display reference point corresponding to the single-hand hold mode; and adjusting a display position of the to-be-moved control, generating a new overlay interface according to an adjusted position of the control, and replacing the to-be-displayed overlay interface with the new overlay interface, where on the new overlay interface, a distance between the display position of the to-be-moved control and the display reference point is less than a specified threshold. The method and apparatus provided by the present invention resolve a problem of user operation inconvenience caused by an inappropriate method for displaying a menu on a user interface in the prior art.

### TECHNICAL FIELD

The present invention relates to the field of electronic technologies, and in particular, to a method for displaying a menu on a user interface and a handheld terminal.

### BACKGROUND

Handheld terminals have become indispensable necessities in daily life of people, and importance of the handheld terminals can be seen from any perspective. A current development trend of the handheld terminals is that screens become larger.

However, a palm of a person is fixed in size. Therefore, currently many handheld terminals require that a user should perform an operation with both hands to cover and tap controls on an entire screen. However, sometimes a user has to free one hand for doing another thing, and therefore can only operate a mobile terminal with a single hand. In this case, a finger can tap only in a limited area range, and cannot cover and tap on an entire screen.

In addition, currently, many users play audio and video files by using handheld terminals. To provide a better viewing effect, generally, a handheld terminal provides a full-screen immersive mode. In the full-screen immersive mode, a system menu including a status bar and virtual keys, and an application menu are both hidden dynamically. An application program corresponding to the full-screen immersive mode may use complete screen space (that is, displayed content of the application program is displayed in full screen on a display unit of the terminal), and provide simpler and more pleasant user experience.

When the mobile phone exits an immersive state, immersive menus (including the system menu and the application menu) appear at a top and a bottom of the screen of the mobile phone. The user may control a current application or system by operating the immersive menus to implement corresponding functions.

Because the immersive menus are generally provided at the top and/or bottom of the display screen, in this display mode, there are always some menu areas unreachable to the user during a single-hand operation. Therefore, the prior art has a problem of menu operation inconvenience.

### SUMMARY

The present invention provides a method for displaying a menu on a user interface and a handheld terminal. The method and apparatus provided by the present invention resolve a problem of user operation inconvenience caused by an inappropriate method for displaying a menu on a user interface in the prior art.

According to a first aspect, a method for displaying a menu on a user interface is provided, and the method includes:
when a handheld terminal detects, in a full-screen immersive mode, a first touch operation that meets a first preset condition, obtaining a to-be-displayed overlay interface of an application program corresponding to the full-screen immersive mode, where the to-be-displayed overlay interface is superposed and displayed on currently displayed content of the handheld terminal when being displayed;
determining controls displayed on the to-be-displayed overlay interface;
when determining that a user currently holds the handheld terminal in a single-hand hold mode, determining a display reference point corresponding to the single-hand hold mode, where a distance between the display reference point and a lateral side of the handheld terminal held by the user is less than a specified threshold, and the hold mode includes left-hand hold or right-hand hold;
determining a to-be-moved control from the controls; and
adjusting a display position of the to-be-moved control, generating a new overlay interface according to an adjusted position of the control, and replacing the to-be-displayed overlay interface with the new overlay interface, where on the new overlay interface, a distance between the display position of the to-be-moved control and the display reference point is less than the specified threshold, and functions performed by the handheld terminal are the same when the user operates the to-be-moved control before and after the position adjustment.

With reference to the first aspect, in a first possible implementation, the determining a display reference point corresponding to the single-hand hold mode includes:
determining the lateral side of the handheld terminal held by the user; and
determining, based on the lateral side, a point on the handheld terminal as the display reference point.

With reference to the first possible implementation of the first aspect, in a second possible implementation, the determining, based on the lateral side, a point on the handheld terminal as the display reference point includes:
obtaining a touch track of the first touch operation, and determining, according to a position of an end point of the touch track relative to a start point, a sliding direction corresponding to the touch track; and
determining, based on the lateral side and the sliding direction, a point on the handheld terminal as the display reference point.

With reference to the first or the second possible implementation of the first aspect, in a third possible implementation, determining that the user holds the lateral side of the handheld terminal includes:
with a touch sensor disposed on the lateral side of the handheld terminal, determining, according to a touch signal detected by the touch sensor on the lateral side, that the user holds the lateral side of the handheld terminal.

With reference to the first aspect, or the first to the third possible implementations of the first aspect, in a fourth possible implementation, the determining a to-be-moved control from the controls includes:
detecting a distance between a to-be-displayed position of each of the controls and the display reference point, and when a distance between a to-be-displayed position of any control and the display reference point is greater than the specified threshold, determining that the any control is the to-be-moved control; or
outputting the to-be-displayed overlay interface, detecting whether a second touch operation that meets a second preset condition exists, and determining the to-be-moved control from the controls according to the second touch operation.

With reference to the first aspect, or the first to the fourth possible implementations of the first aspect, in a fifth possible implementation, after the replacing the to-be-displayed overlay interface with the new overlay interface, the method further includes:
obtaining current display coordinates of a first control on the new overlay interface when the user operates the first control in the to-be-moved control after the position adjustment;
determining, according to the current display coordinates, corresponding original coordinates of the first control on the to-be-displayed overlay interface; and
invoking a corresponding function according to the original coordinates.

With reference to the first aspect, or the first to the fifth possible implementations of the first aspect, in a sixth possible implementation, the method further includes: displaying the to-be-moved control on the new overlay interface in a floating control mode.

According to a second aspect, a handheld terminal is provided, and the handheld terminal includes:
an input unit, configured to detect, when the handheld terminal is in a full-screen immersive mode, whether a first touch operation that meets a first preset condition exists; and
a processor, configured to: if the first touch operation that meets the first preset condition exists, obtain a to-be-displayed overlay interface of an application program corresponding to the full-screen immersive mode, and determine controls displayed on the to-be-displayed overlay interface; when determining that a user currently holds the handheld terminal in a single-hand hold mode, determine a display reference point corresponding to the single-hand hold mode; determine a to-be-moved control from the controls; and adjust a display position of the to-be-moved control, generate a new overlay interface according to an adjusted position of the control, and replace the to-be-displayed overlay interface with the new overlay interface, where on the new overlay interface, a distance between the display position of the to-be-moved control and the display reference point is less than a specified threshold, functions performed by the handheld terminal are the same when the user operates the to-be-moved control before and after the position adjustment, the to-be-displayed overlay interface is superposed and displayed on currently displayed content when being displayed, a distance between the display reference point and a lateral side of the handheld terminal held by the user is less than the specified threshold, and the hold mode includes left-hand hold or right-hand hold.

With reference to the second aspect, in a first possible implementation, the determining, by the processor, a display reference point corresponding to the single-hand hold mode specifically includes: determining the lateral side of the handheld terminal held by the user, and determining, based on the lateral side, a point on the handheld terminal as the display reference point.

With reference to the first possible implementation of the second aspect, in a second possible implementation, the determining, by the controller based on the lateral side, a point on the handheld terminal as the display reference point specifically includes: obtaining a touch track of the first touch operation, and determining, according to a position of an end point of the touch track relative to a start point, a sliding direction corresponding to the touch track; and determining, based on the lateral side and the sliding direction, a point on the handheld terminal as the display reference point.

With reference to the first or the second possible implementation of the second aspect, in a third possible implementation, the input unit is further configured to detect a touch signal, so that the processor determines, according to the touch signal, that the user holds the lateral side of the handheld terminal.

With reference to the second aspect, or the first to the third possible implementations of the second aspect, in a fourth possible implementation, the determining, by the processor, a to-be-moved control from the controls specifically includes: detecting a distance between a to-be-displayed position of each of the controls and the display reference point, and when a distance between a to-be-displayed position of any control and the display reference point is greater than the specified threshold, determining that the any control is the to-be-moved control; or outputting the to-be-displayed overlay interface, detecting whether a second touch operation that meets a second preset condition exists, and determining the to-be-moved control from the controls according to the second touch operation.

With reference to the second aspect, or the first to the fourth possible implementations of the second aspect, in a fifth possible implementation, after replacing the to-be-displayed overlay interface with the new overlay interface, the processor is further configured to: obtain current display coordinates of a first control on the new overlay interface when the user operates the first control in the to-be-moved control after the position adjustment; determine, according to the current display coordinates, corresponding original coordinates of the first control on the to-be-displayed overlay interface; and invoke a corresponding function according to the original coordinates.

With reference to the second aspect, or the first to the fifth possible implementations of the second aspect, in a sixth possible implementation, the processor is further configured to display the to-be-moved control on the new overlay interface in a floating control mode.

One or two of the foregoing technical solutions have at least the following technical effects:

In the method and apparatus provided by the embodiments of the present invention, an operating system needs to process a to-be-displayed overlay interface and then present a processed interface, so that after a user taps on a screen, a menu/button/option that should be displayed by an application program is moved to an area that a finger can conveniently operate. A function of a moved control is the same as a corresponding function of the control before the moving. When the user taps the moved control, the corresponding function of the control in an original position can be normally triggered. Therefore, menus provided by the embodiments of the present invention can be touched by the user more conveniently, and interfaces are pleasant and elegant.

### BRIEF DESCRIPTION OF DRAWINGS

FIG. 1 is a schematic flowchart of a method for displaying a menu on a user interface according to an embodiment of the present invention;

FIG. 2 is a schematic diagram of comparison between to-be-moved controls before and after position moving when a user holds a handheld terminal with a right hand according to an embodiment of the present invention;

FIG. 3 is a schematic diagram of comparison between to-be-moved controls before and after position moving when a user holds a handheld terminal with a left hand according to an embodiment of the present invention;

FIG. 4 is a schematic diagram of comparison when a user controls a moved control by performing a sliding operation according to an embodiment of the present invention;

FIG. 5 is a schematic implementation diagram for determining a moving position of a control by using a touch track according to an embodiment of the present invention;

FIG. 6 and FIG. 7 are schematic diagrams when moving controls are displayed in a floating mode according to an embodiment of the present invention;

FIG. 8 is a schematic structural diagram of a handheld terminal according to an embodiment of the present invention; and

FIG. 9 is a schematic structural diagram of another handheld terminal according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

The following further describes the embodiments of the present invention in detail with reference to this specification.

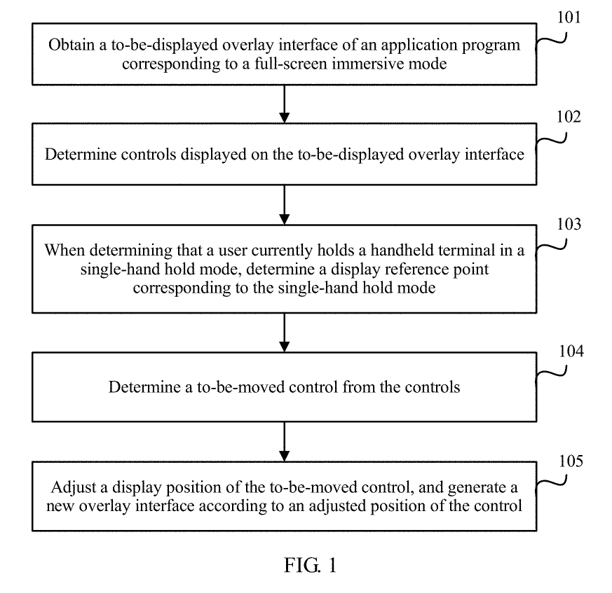

In the prior art, an application program displays content in full screen in a full-screen immersive mode, but does not display any menu, button, or option (nor displays a status bar or a navigation bar). When a user taps on the screen, the application program superposes a to-be-displayed menu, button, or option on the content displayed in full screen, for use by the user. Based on a feature of the full-screen immersive mode, an embodiment of the present invention provides a method for displaying a menu on a user interface, so that after a user taps on a screen, a menu/button/option that should be displayed by an application program is moved to an area that a finger of the user can conveniently operate. In the method, an overlay interface to be superposed and displayed on a currently displayed interface is processed, and then superposed and displayed on the currently displayed interface after the processing. As shown in FIG. 1, a specific implementation of the method provided by this embodiment of the present invention includes the following steps.

Step 101: When a handheld terminal detects, in a full-screen immersive mode, a first touch operation that meets a first preset condition, obtain a to-be-displayed overlay interface of an application program corresponding to the full-screen immersive mode, where the to-be-displayed overlay interface is superposed and displayed on currently displayed content when being displayed.

In this embodiment, the first touch operation that meets the first preset condition may a preset operation that can be identified by the handheld terminal. In addition, the control is a control in an application menu.

Before the to-be-displayed overlay interface of the application program is displayed on the screen, a system first needs to load the to-be-displayed overlay interface to a memory. The system can parse the to-be-displayed overlay interface to determine controls on the interface only after the loading is complete. The system may obtain information about the controls on the interface. The information about the controls includes information such as IDs, names, positions, and sizes of the controls.

Step 102: Determine controls displayed on the to-be-displayed overlay interface.

In a conventional immersive mode, to provide a best viewing effect for a user, all controls corresponding to currently displayed content are hidden. Generally, when the user operates the terminal, an application corresponding to the currently displayed content displays and sets all controls on the overlay interface. Based on this implementation, in the solution provided by the present invention, positions of the controls may be adjusted before the overlay interface is displayed, so that displayed controls after the adjustment can be operated more conveniently. Certainly, to ensure simplicity of the displayed interface, regardless of whether the positions of the controls are adjusted, only one of same controls on the overlay interface is displayed.

Step 103: When determining that a user currently holds the handheld terminal in a single-hand hold mode, determine a display reference point corresponding to the single-hand hold mode, where a distance between the display reference point and a lateral side of the handheld terminal held by the user is less than a specified threshold, and the hold mode includes left-hand hold or right-hand hold.

In this example, the display reference point is used for determining a position of a control after the control is moved. Therefore, to move a control that the user cannot conveniently operate, to a position that the user can conveniently operate, the display reference point may be set in a position in which the user holds the terminal. A specific manner of determining the display reference point corresponding to the single-hand hold mode may be as follows:

In this example, after the position in which the user holds the terminal is determined, a position to which a to-be-moved control is moved and in which the user can conveniently perform an operation may be determined based on the position. Therefore, after the position in which the user holds the terminal is determined, a position may be determined as the display reference point based on a lateral side and a bottom side of the handheld terminal held by the user or corner vertices corresponding to the lateral side and the bottom side. A specific implementation is not limited in this embodiment, as long as the user can conveniently perform an operation. To describe the solution of this embodiment of the present invention, the following uses an example in which the user holds the lateral side of the handheld terminal:
A. Determine the lateral side of the handheld terminal held by the user.
B. Determine, based on the lateral side, a point on the handheld terminal as the display reference point.

A specific implementation of determining that the user holds the lateral side of the handheld terminal may be:
with a touch sensor disposed on the lateral side of the handheld terminal, determining, according to a touch signal detected by the touch sensor on the lateral side, that the user holds the lateral side of the handheld terminal.

Step 104: Determine a to-be-moved control from the controls.

In this embodiment, all controls on the overlay interface may be moved to form a new elegant interface that has a unified format. In addition, only a control that the user cannot conveniently operate may be moved from a perspective of a practical application (according to existing statistics in the industry, areas that are not easily operable on different terminal screens are determined). Therefore, after all controls included in the overlay interface are determined, some controls may be selected or all the controls may be selected as to-be-moved controls.

If some controls need to be selected from the controls and moved, the determining a to-be-moved control from the controls includes step A or B.

A. Detect a distance between a to-be-displayed position of each of the controls and the display reference point, and when a distance between a to-be-displayed position of any control and the display reference point is greater than the specified threshold, determine that the any control is the to-be-moved control.

In this implementation, because controls used in this embodiment are displayed in fixed positions on the to-be-displayed overlay interface, each control has a parameter or an attribute for determining a display position. Therefore, in this embodiment, a position in which each control should be displayed when each control is displayed on the screen may be determined according to the parameter or attribute. Although the control is not actually displayed on a display apparatus of the mobile terminal in this case, a position of the control to be displayed on the display apparatus, namely, a to-be-displayed position, may be determined according to the related parameter or attribute.

B. Output the to-be-displayed overlay interface, detect whether a second touch operation that meets a second preset condition exists, and determine the to-be-moved control from the controls according to the second touch operation.

In this embodiment, a final objective of adjusting the control is to achieve use convenience for the user. Therefore, to meet a requirement of each user, the to-be-displayed overlay interface is displayed in a preview form. Then the user may determine, according to displayed content, which external controls cannot be conveniently operated, and therefore, may select, from the controls by performing a touch operation, a to-be-moved control that requires position moving.

Step 105: Adjust a display position of the to-be-moved control, generate a new overlay interface according to an adjusted position of the control, and replace the to-be-displayed overlay interface with the new overlay interface, where on the new overlay interface, a distance between the display position of the to-be-moved control and the display reference point is less than the specified threshold, and functions performed by the handheld terminal are the same when the user operates the to-be-moved control before and after the position adjustment.

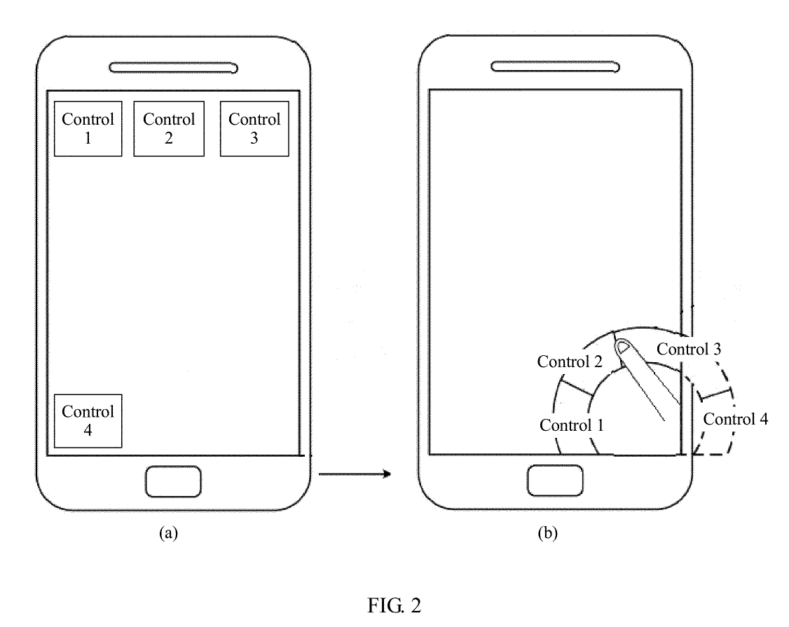

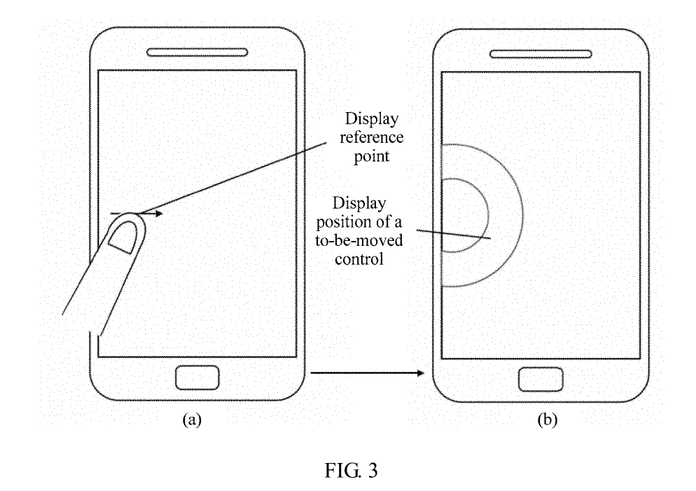

On the new overlay interface, positions of all controls are more convenient for the user to perform operations. To achieve the objective, when positions of controls are set, a specific implementation may be:
collecting a set of touch points of a thumb on the screen when the user holds the mobile phone, estimating a length of the thumb of the user, calculating a range of angles at which the thumb of the user can rotate by using a root of the finger as a base point, and a longest distance that the thumb can extend, and finally calculating a range that can be covered. That is, based on the display reference point (which may be the root of the finger in this example) determined in step 102, the to-be-moved control is displayed in the coverage range that is finally obtained through calculation, that is, a distance between a display position of the moved control and the display reference point is less than the specified threshold (as shown in FIG. 2, FIG. 2(a) shows controls before the moving, and FIG. 2(b) shows controls after the moving). The case shown in FIG. 2 is a specific implementation case in which the user holds the handheld terminal with a right hand. When the user holds the handheld terminal with a left hand, correspondingly the control may be moved to a position on a left side of the handheld terminal for displaying, specifically as shown in FIG. 3.

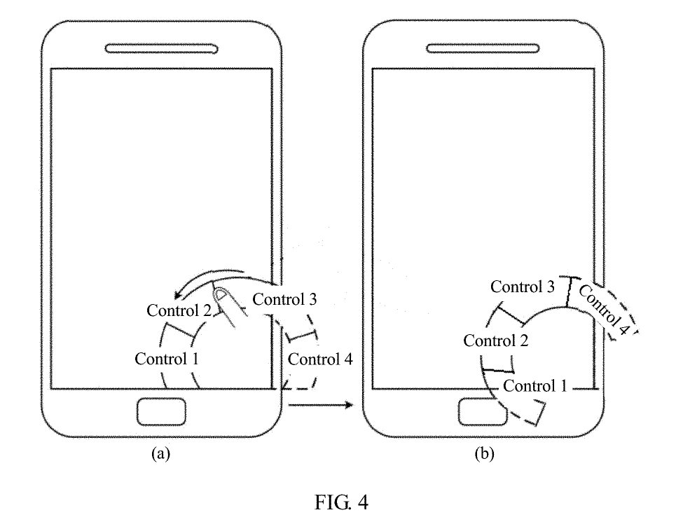

In this embodiment, after being moved, the to-be-moved controls may be displayed independently or may be combined to form a menu bar as shown by an arc menu shown in b in FIG. 2 (The specific example shown in FIG. 2 is only an optimal example for implementing this embodiment of the present invention, but the implementation of the solution provided by this embodiment of the present invention is not limited to the manner shown in FIG. 2. In a specific application environment, the menu may be set in various forms such as a rectangle and an oval for reasons of a design requirement, a user operation convenience requirement, and the like). In the case of the menu format, controls in the menu may be displayed by left-to-right and/or up-to-down scrolling of a user gesture (if the user performs a right-sliding touch operation, display positions of the controls in the menu may be correspondingly adjusted, and a specific effect diagram is shown in FIG. 4, where FIG. 4(a) shows display positions before the scrolling, and FIG. 4(b) shows display positions after the scrolling), or may be displayed by automatic scrolling (similar to a scrolling message effect); (optionally) a lower menu on the screen is not moved but only its display range is narrowed, and only an upper menu on the screen is moved close to the lower menu on the screen.

Optionally, in this embodiment, the first touch operation performed by the user is a specific sliding operation. The handheld terminal may determine, based on the sliding operation, to enable control moving, and determine, according to a track corresponding to the sliding operation, a specific position to which a control needs to be moved. In this case, a specific implementation of determining, based on the lateral side, a point on the handheld terminal as the display reference point may be:
obtaining a touch track of the first touch operation, and determining, according to a position of an end point of the touch track relative to a start point, a sliding direction corresponding to the touch track; and
determining, based on the lateral side and the sliding direction, a point on the handheld terminal as the display reference point.

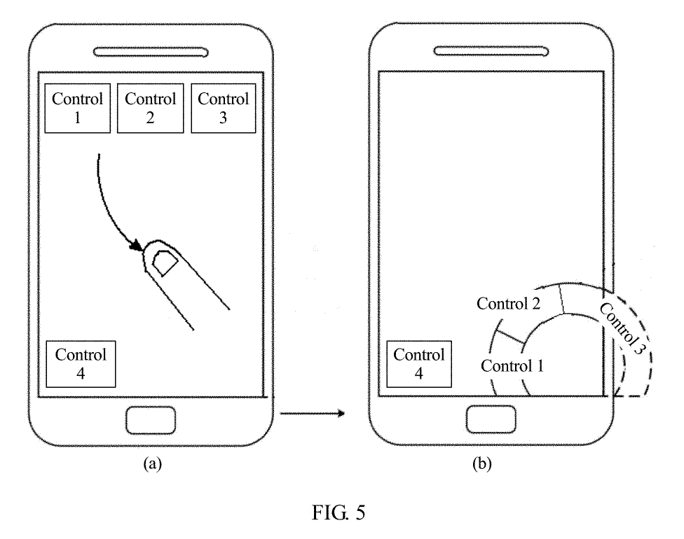

In this embodiment, a final display reference point may be determined after the touch track of the first touch operation is combined with the lateral side held by the user, so that the determined display reference point is more convenient for the user to perform an operation, as shown in the embodiment in FIG. 5.

In FIG. 5(a) (a control 1, a control 2, and a control 3 that cannot be conveniently operated by the user in the figure), if the user inputs an upper left to lower right sliding operation on the handheld terminal by using a finger, the handheld terminal may determine, according to the operation, that the user needs to move controls in an upper-left corner of the handheld terminal to a lower-right corner (an interface after the moving is shown in FIG. 5(b)). In this case, correspondingly, it may be determined, according to a sliding direction of a touch track, that a moving direction of the controls is also from the upper left to the lower right. According to analysis, it may be determined that a control that cannot be conveniently operated is moved to a lower-right position of the handheld terminal, so that the user can operate the control more conveniently. Therefore, a specific implementation may be:
(1) determining a lateral side corresponding to the hold mode of the user on the handheld terminal, determining two corner vertices of the handheld terminal corresponding to the lateral side, determining an intersection point of the lateral side and the sliding direction corresponding to the touch track of the first touch operation, and determining, from the two corner vertices, a corner vertex with a shorter distance to the intersection point as the display reference point (as shown in the part b in FIG. 5); or
(2) determining a lateral side corresponding to the hold mode of the user on the handheld terminal, determining an intersection point of the lateral side and the sliding direction corresponding to the touch track of the first touch operation, and using the intersection point as the display reference point.

In this embodiment, to achieve a better displaying effect, after the display reference point and the to-be-moved control are determined, a process of moving the control from an original position to the display reference point may be further displayed in a form of a moving picture.

After the controls on the overlay interface undergo position moving and recombination in the foregoing manner, it should be further ensured that a function of each control is not changed. Therefore, in this embodiment, after a control is moved, function mapping needs to be performed on the moved control and the control before the moving, so that when the user taps the moved control, the corresponding function of the control in the original position can be triggered normally; then the processed overlay interface is presented. A specific implementation may be:
obtaining current display coordinates of a first control on the new overlay interface when the user operates the first control in the to-be-moved control after the position adjustment;
determining, according to the current display coordinates, corresponding original coordinates of the first control on the to-be-displayed overlay interface; and
invoking a corresponding function according to the original coordinates.

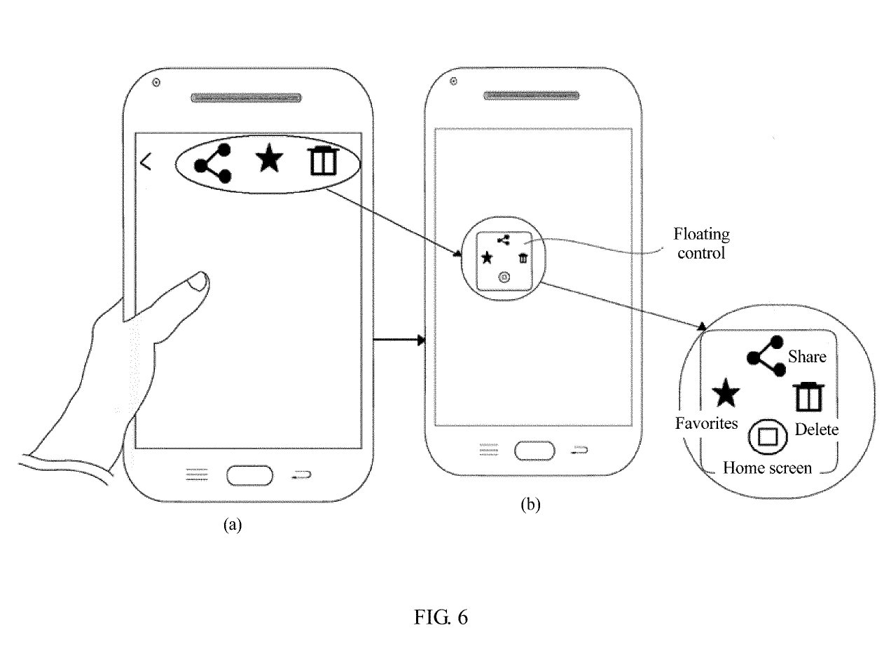

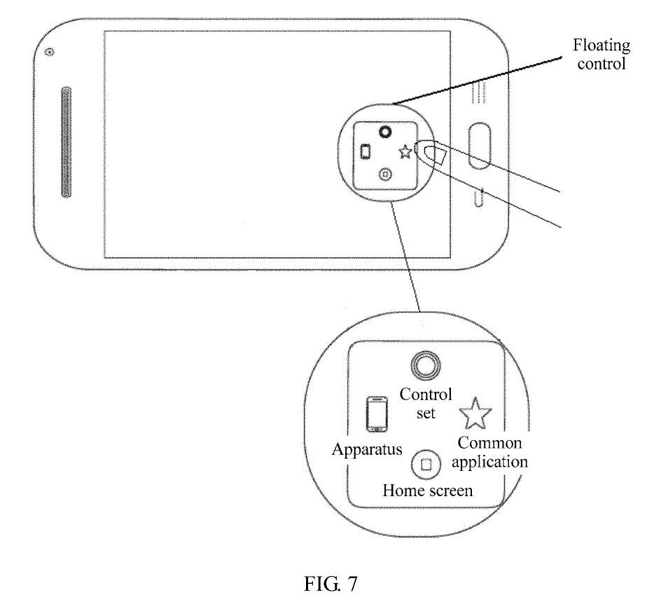

Optionally, the to-be-moved control in this example may be further displayed on the new overlay interface in a floating control mode (in this embodiment, a floating control is a control that may move freely according to a dragging operation of the user), so that the user can conveniently perform an operation when holding the handheld terminal with either the left hand or the right hand. As shown in FIG. 6, in this example, three controls that cannot be conveniently operated form a circular floating control in FIG. 6b (FIG. 6 is an operation on the handheld terminal in portrait orientation, and FIG. 7 is an operation on the handheld terminal in landscape orientation).

### Embodiment

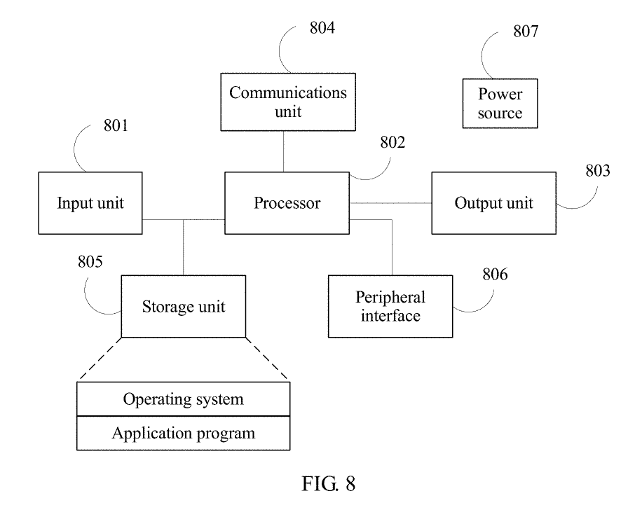

FIG. 8 shows a handheld terminal according to a specific implementation of the present invention. The handheld terminal includes an input unit 801, a processor 802, an output unit 803, a communications unit 804, a storage unit 805, a peripheral interface 806, and a power source 807. The units perform communication by using one or more buses. Persons skilled in the art may understand that, a structure of the handheld terminal shown in the figure does not constitute a limitation to the present invention. The structure may be a bus structure, or may be a star structure. Further, a quantity of parts included may be greater or less than that shown in the figure, or some parts are combined, or parts are arranged in a different manner. In an implementation of the present invention, the handheld terminal may be any mobile or portable handheld terminal, including but not limited to a mobile phone, a mobile computer, a tablet computer, a personal digital assistant (Personal Digital Assistant, PDA), a media player, or a combination of two or more thereof.

The input unit is configured to exchange information between a user and the handheld terminal and/or input information to the handheld terminal. For example, the input unit may receive numeral or character information input by the user, to generate a signal input related to a user setting or function control. In a specific implementation of the present invention, the input unit may be a touch panel, or may be another human-machine interaction interface, for example, a physical input key or a microphone, or may be another external information acquisition apparatus such as a camera. The touch panel, also referred to as a touchscreen, may collect operation actions of the user touching or approaching the touch panel. For example, the user performs an operation action on the touch panel or a position near the touch panel by using any appropriate object or accessory such as a finger or a stylus, and drives a corresponding connection apparatus according to a preset program. Optionally, the touch panel may include two parts: a touch detection apparatus and a touch controller. The touch detection apparatus detects a touch operation of the user, converts the detected touch operation into an electrical signal, and transmits the electrical signal to the touch controller. The touch controller receives the electrical signal from the touch detection apparatus, converts it into touch point coordinates, and sends the touch point coordinates to the processor. The touch controller may further receive and execute a command sent by the processing unit. In addition, the type of the touch panel may be resistive, capacitive, infrared (Infrared), surface acoustic wave, or the like. In other implementations of the present invention, the physical input key used by the input unit may include but is not limited to one or more of a physical keyboard, a function key (such as a volume control button or a power on/off button), a trackball, a mouse, a joystick, or the like. The input unit in a microphone form may capture a speech input by the user or an environment, and convert the speech into a command in an electrical signal form and executable by the processing unit.

In other implementations of the present invention, the input unit may also be various sensors, for example, a Hall component configured to sense a physical quantity of the handheld terminal, for example, force, torque, pressure, stress, location, displacement, speed, acceleration, angle, angular velocity, a quantity of revolutions, rotational speed, and time at which a working status changes, and convert the physical quantity into electric energy for performing detection and control. Other sensors may further include a gravity sensor, a tri-axis accelerometer, a gyroscope, an electronic compass, an ambient light sensor, a proximity sensor, a temperature sensor, a humidity sensor, a pressure sensor, a pulse sensor, a fingerprint recognizer, and the like.

The output unit includes but is not limited to an image output unit and an audio output unit. The image output unit is configured to output a text, an image, and/or a video. The image output unit may include a display panel, for example, a display panel configured in a form of an LCD (Liquid Crystal Display, liquid crystal display), an OLED (Organic Light-Emitting Diode, organic light-emitting diode), or a field emission display (field emission display, FED for short). Alternatively, the image output unit may include a reflective display, for example, an electrophoretic (electrophoretic) display, or a display using an interferometric modulation of light (Interferometric Modulation of Light) technology. The image output unit may include a single display or multiple displays of different sizes. In a specific implementation of the present invention, the touch panel used by the input unit may also be used as a display panel of the output unit. For example, after the touch panel detects a touch or approaching gesture operation on the touch panel, the touch panel transmits the operation to the processing unit to determine a type of a touch event. Afterward, the processing unit provides a corresponding visual output on the display panel according to the type of the touch event. Although the input unit and the output unit are used as two independent parts for implementing input and output functions of the handheld terminal in FIG. 8, in some embodiments, the touch panel and the display panel may be integrated for implementing the input and output functions of the handheld terminal. For example, the image output unit may display various graphical user interfaces (Graphical User Interface, GUI for short) as virtual control components, including but not limited to a window, a scroll bar, an icon, and a clipbook for the user to perform a touch operation on the virtual control components.

In a specific implementation of the present invention, the image output unit includes a filter and an amplifier that are configured to filter and amplify a video output by the processing unit. The audio output unit includes a digital-to-analog converter, configured to convert an audio signal output by the processing unit from a digital format to an analog format.

The processor is a control center of the handheld terminal. The processor uses various interfaces and lines to connect each part of the entire mobile terminal, and by running or executing a software program and/or module stored in the storage unit, and invoking data stored in the storage unit, performs various functions of the mobile terminal and/or processes data. The system control module may include an integrated circuit (Integrated Circuit, IC for short), for example, may include a single packaged IC, or may include multiple interconnected packaged ICs that have a same function or different functions. For example, the processor may include only a central processing unit (Central Processing Unit, CPU for short), or may be a combination of a GPU, a digital signal processor (Digital Signal Processor, DSP for short), and a control chip (for example, a baseband chip) in a communications management module. In an implementation of the present invention, the CPU may be a single operation core, or may include multiple operation cores.

The communications unit is configured to establish a communications channel, so that the handheld terminal can perform voice communication, text communication, and data communication with a remote handheld terminal or server by using the communications channel. The communications unit may include a communications module such as a wireless local area network (Wireless Local Area Network, wireless LAN for short) module, a Bluetooth module, or a baseband (Base Band) module, and a radio frequency (Radio Frequency, RF for short) circuit corresponding to the communications module, and is configured to perform wireless local area network communication, Bluetooth communication, infrared communication, and/or communication in a cellular communications system, for example, Wideband Code Division Multiple Access (Wideband Code Division Multiple Access, W-CDMA for short), and/or High Speed Downlink Packet Access (High Speed Downlink Packet Access, HSDPA for short). The communications module is configured to control communication of each component in the handheld terminal, and may support direct memory access (Direct Memory Access).

In different implementations of the present invention, each communications module in the communications unit generally exists in a form of an integrated circuit chip (Integrated Circuit Chip), and a combination of the communications modules may be selected, without necessarily including all communications modules and corresponding antenna groups. For example, the communications unit may include only a baseband chip, a radio frequency chip, and a corresponding antenna to provide a communications function in a cellular communications system. By using a wireless communications connection established by the communications unit, for example, wireless local area network access or WCDMA access, the handheld terminal may connect to a cellular network (Cellular Network) or the Internet (Internet).

The radio frequency circuit is configured to receive or transmit information or receive or transmit a signal in a call process. For example, after receiving downlink information of a base station, the radio frequency circuit sends the downlink information to the processing unit for processing; in addition, sends uplink data to the base station. Generally, the radio frequency circuit includes well-known circuits for performing these functions, including but not limited to an antenna system, a radio frequency transceiver, one or more amplifiers, a tuner, one or more oscillators, a digital signal processor, a codec (Codec) chipset, a subscriber identity module (SIM), a memory, and the like. In addition, the radio frequency circuit may further communicate with a network and other devices through wireless communication. The wireless communication may use any communications standard or protocol, including but not limited to GSM (Global System of Mobile communication, Global System for Mobile communication), GPRS (General Packet Radio Service, General Packet Radio Service), CDMA (Code Division Multiple Access, Code Division Multiple Access), WCDMA (Wideband Code Division Multiple Access, Wideband Code Division Multiple Access), High Speed Downlink Packet Access technology (High Speed Downlink Packet Access, HSDPA), LTE (Long Term Evolution, Long Term Evolution), email, SMS (Short Messaging Service, short message service), and the like.

The storage unit may be configured to store a software program and module. By running the software program and module stored in the storage unit, the processing unit executes various function applications of the handheld terminal and implements data processing. The storage unit mainly includes a program storage area and a data storage area. The program storage area may store an operating system, an application program required by at least one function, such as an audio playing program and an image playing program. The data storage area may store data (such as audio data or a phone book) that is created according to use of the handheld terminal, or the like. In a specific implementation of the present invention, the storage unit may include a volatile memory, for example, a nonvolatile dynamic random access memory (Nonvolatile Random Access Memory, NVRAM for short), a phase change random access memory (Phase Change RAM, PRAM for short), or a magnetoresistive random access memory (Magnetoresistive RAM, MRAM for short), and may further include a nonvolatile memory, for example, at least one disk storage device, an electrically erasable programmable read-only memory (Electrically Erasable Programmable Read-Only Memory, EEPROM for short), or a flash memory device such as a NOR flash memory (NOR flash memory) or a NAND flash (NAND flash memory). The nonvolatile memory stores the operating system and application program executed by the processing unit. The processing unit loads a running program and data from the nonvolatile memory to memory and stores digital content in a mass storage apparatus. The operating system includes various components and/or drivers that are configured to control and manage routine system tasks, for example, memory management, storage device control, power management, and the like, and are helpful for communication between software and hardware.

In an implementation of the present invention, the operating system may be an Android system of Google Inc., an iOS system developed by Apple Inc., a Windows system or a Windows Phone system developed by Microsoft Corporation, or the like, or is an embedded operating system such as Vxworks.

The application program includes any application installed on the handheld terminal, including but not limited to a browser, email, an instant messaging service, text processing, keyboard virtualization, widget (Widget), encryption, digital rights management, speech recognition, speech replication, positioning (for example, a function provided by a global positioning system), music playing, or the like.

The power source is configured to supply power to different components of the handheld terminal to keep the components running. A general understanding is that the power source may be a built-in battery, for example, a common lithium-ion battery or a common NiMH battery, or includes an external power source directly supplying power to the handheld terminal, for example, an AC adapter. In some implementations of the present invention, the power source may be further defined more extensively, for example, may further include a power management system, a recharge system, a power failure detection circuit, a power converter or inverter, a power status indicator (such as a light-emitting diode), and any other component associated with electric energy generation, management, and distribution for the handheld terminal.

Based on the structure shown in FIG. 8, to implement the solution of the embodiment shown in FIG. 1, a specific implementation may be as follows:

The input unit 801 is configured to detect, when the handheld terminal is in a full-screen immersive mode, whether a first touch operation that meets a first preset condition exists.

In this embodiment, the input unit 801 is mainly configured to receive and detect input information, and may include multiple physical structures in a specific implementation. Herein, the touch operation may be detected by a physical structure that can recognize the touch operation, such as a touchscreen.

The processor 802 invokes a program in the storage unit 805 to: if the first touch operation that meets the first preset condition exists, obtain a to-be-displayed overlay interface of an application program corresponding to the full-screen immersive mode, and determine controls displayed on the to-be-displayed overlay interface; when determining that the user currently holds the handheld terminal in a single-hand hold mode, determine a display reference point corresponding to the single-hand hold mode; determine a to-be-moved control from the controls; and adjust a display position of the to-be-moved control, generate a new overlay interface according to an adjusted position of the control, and replace the to-be-displayed overlay interface with the new overlay interface, where on the new overlay interface, a distance between the display position of the to-be-moved control and the display reference point is less than a specified threshold, functions performed by the handheld terminal are the same when the user operates the to-be-moved control before and after the position adjustment, the to-be-displayed overlay interface is superposed and displayed on currently displayed content when being displayed, a distance between the display reference point and a lateral side of the handheld terminal held by the user is less than the specified threshold, and the hold mode includes left-hand hold or right-hand hold.

Optionally, the processor is specifically configured to determine the lateral side of the handheld terminal held by the user, and determine, based on the lateral side, a point on the handheld terminal as the display reference point.

To implement the determining, based on the lateral side, a point on the handheld terminal as the display reference point, specifically, the processor is specifically configured to: obtain a touch track of the first touch operation, and determine, according to a position of an end point of the touch track relative to a start point, a sliding direction corresponding to the touch track; and determine, based on the lateral side and the sliding direction, a point on the handheld terminal as the display reference point.

Optionally, the input unit is further configured to detect a touch signal, so that the processor determines, according to the touch signal, that the user holds the lateral side of the handheld terminal.

Herein the input unit detects the touch signal. In this case, a corresponding physical structure may be a physical structure that can recognize the touch signal, such as a touch sensor.

Optionally, the processor is specifically configured to: detect a distance between a to-be-displayed position of each of the controls and the display reference point, and when a distance between a to-be-displayed position of any control and the display reference point is greater than the specified threshold, determine that the any control is the to-be-moved control; or output the to-be-displayed overlay interface, detect whether a second touch operation that meets a second preset condition exists, and determine the to-be-moved control from the controls according to the second touch operation.

Optionally, the processor is further configured to: obtain current display coordinates of a first control on the new overlay interface when the user operates the first control in the to-be-moved control after the position adjustment; determine, according to the current display coordinates, corresponding original coordinates of the first control on the to-be-displayed overlay interface; and invoke a corresponding function according to the original coordinates.

Optionally, the processor is further configured to display the to-be-moved control on the new overlay interface in a floating control mode.

### Embodiment

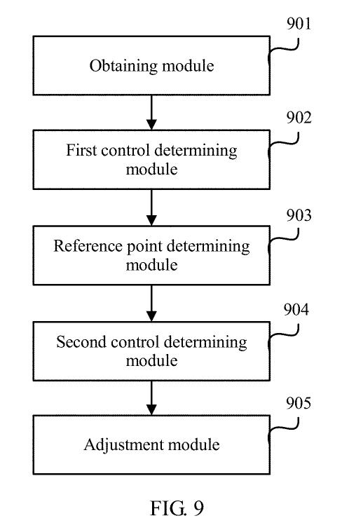

As shown in FIG. 9, this embodiment of the present invention further provides a handheld terminal. The handheld terminal includes:
an obtaining module 901, configured to: when the handheld terminal detects, in a full-screen immersive mode, a first touch operation that meets a first preset condition, obtain a to-be-displayed overlay interface of an application program corresponding to the full-screen immersive mode, where the to-be-displayed overlay interface is superposed and displayed on currently displayed content when being displayed;
a first control determining module 902, configured to determine controls displayed on the to-be-displayed overlay interface;
a reference point determining module 903, configured to: when determining that a user currently holds the handheld terminal in a single-hand hold mode, determine a display reference point corresponding to the single-hand hold mode, where a distance between the display reference point and a lateral side of the handheld terminal held by the user is less than a specified threshold, and the hold mode includes left-hand hold or right-hand hold;
a second control determining module 904, configured to determine a to-be-moved control from the controls; and
an adjustment module 905, configured to: adjust a display position of the to-be-moved control, generate a new overlay interface according to an adjusted position of the control, and replace the to-be-displayed overlay interface with the new overlay interface, where on the new overlay interface, a distance between the display position of the to-be-moved control and the display reference point is less than the specified threshold, and functions performed by the handheld terminal are the same when the user operates the to-be-moved control before and after the position adjustment.

Optionally, the determining, by the reference point determining module 903, a display reference point corresponding to the single-hand hold mode includes:
determining the lateral side of the handheld terminal held by the user, and determining, based on the lateral side, a point on the handheld terminal as the display reference point.

Further, the reference point determining module 903 is specifically configured to obtain a touch track of the first touch operation, and determine, according to a position of an end point of the touch track relative to a start point, a sliding direction corresponding to the touch track; and determine, based on the lateral side and the sliding direction, a point on the handheld terminal as the display reference point.

Optionally, a touch sensor is disposed on the lateral side of the handheld terminal, and the reference point determining module 903 is further configured to determine, according to a touch signal detected by the touch sensor on the lateral side, that the user holds the lateral side of the handheld terminal.

Optionally, the second control determining module 904 is specifically configured to: detect a distance between a to-be-displayed position of each of the controls and the display reference point, and when a distance between a to-be-displayed position of any control and the display reference point is greater than the specified threshold, determine that the any control is the to-be-moved control; or output the to-be-displayed overlay interface, detect whether a second touch operation that meets a second preset condition exists, and determine the to-be-moved control from the controls according to the second touch operation.

Optionally, the handheld terminal further includes:
a function mapping module, configured to: obtain current display coordinates of a first control on the new overlay interface when the user operates the first control in the to-be-moved control after the position adjustment; determine, according to the current display coordinates, corresponding original coordinates of the first control on the to-be-displayed overlay interface; and invoke a corresponding function according to the original coordinates.

One or more technical solutions provided by the embodiments of this application have at least the following technical effects:

In the method and apparatus provided by the embodiments of the present invention, an operating system needs to process a to-be-displayed overlay interface and then present a processed interface, so that after a user taps on a screen, a menu/button/option that should be displayed by an application program is moved to an area that a finger can conveniently operate. A function of a moved control is the same as a corresponding function of the control before the moving. When the user taps the moved control, the corresponding function of the control in an original position can be normally triggered. Therefore, menus provided by the embodiments of the present invention can be touched by the user more conveniently, and interfaces are pleasant and elegant.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Obviously, persons skilled in the art can make various modifications and variations to the present invention without departing from the spirit and scope of the present invention. The present invention is intended to cover these modifications and variations provided that they fall within the scope of protection defined by the following claims and their equivalent technologies.

1-14. (canceled)

15. A method for displaying a menu on a user interface, wherein the method comprises:
when a handheld terminal detects that, in a full-screen immersive mode, a first touch operation meets a first preset condition, obtaining a to-be-displayed overlay interface of an application program corresponding to the full-screen immersive mode, wherein the to-be-displayed overlay interface is superposed and displayed on currently displayed content of the handheld terminal when being displayed;
determining controls displayed on the to-be-displayed overlay interface;
when determining that a user currently holds the handheld terminal in a single-hand hold mode, determining a display reference point corresponding to the single-hand hold mode, wherein a distance between the display reference point and a lateral side of the handheld terminal held by the user is less than a specified threshold, and the hold mode comprises left-hand hold or right-hand hold;
determining a to-be-moved control from the controls;
adjusting a display position of the to-be-moved control, generating a new overlay interface according to an adjusted position of the control; and
replacing the to-be-displayed overlay interface with the new overlay interface, wherein on the new overlay interface, a distance between the display position of the to-be-moved control and the display reference point is less than the specified threshold, and functions performed by the handheld terminal are the same when the user operates the to-be-moved control before and after the position adjustment.

16. The method according to claim 15, wherein determining the display reference point corresponding to the single-hand hold mode comprises:
determining the lateral side of the handheld terminal held by the user; and
determining, based on the lateral side, a point on the handheld terminal as the display reference point.

17. The method according to claim 16, wherein determining, based on the lateral side, the point on the handheld terminal as the display reference point comprises:
obtaining a touch track of the first touch operation, and determining, according to a position of an end point of the touch track relative to a start point, a sliding direction corresponding to the touch track; and
determining, based on the lateral side and the sliding direction, a point on the handheld terminal as the display reference point.

18. The method according to claim 16, wherein determining that the user holds the lateral side of the handheld terminal comprises:
determining, according to a touch signal detected by a touch sensor disposed on the lateral side, that the user holds the lateral side of the handheld terminal.

19. The method according to claim 15, wherein determining the to-be-moved control from the controls comprises:
detecting a distance between a to-be-displayed position of each of the controls and the display reference point, and when a distance between a to-be-displayed position of any control and the display reference point is greater than the specified threshold, determining that the any control is the to-be-moved control; or
outputting the to-be-displayed overlay interface, detecting whether a second touch operation that meets a second preset condition exists, and if the second touch operation that meets the second preset condition exists, determining the to-be-moved control from the controls according to the second touch operation.

20. The method according to any one of claim 15, wherein after the replacing the to-be-displayed overlay interface with the new overlay interface, the method further comprises:
obtaining current display coordinates of a first control on the new overlay interface when the user operates the first control in the to-be-moved control after the position adjustment;
determining, according to the current display coordinates of the first control, corresponding original coordinates of the first control on the to-be-displayed overlay interface; and
invoking a corresponding function according to the original coordinates.

21. The method according to claim 15, wherein the method further comprises: displaying the to-be-moved control on the new overlay interface in a floating control mode.

22. A handheld terminal, wherein the handheld terminal comprises:
an input unit, configured to detect, when the handheld terminal is in a full-screen immersive mode, whether a first touch operation that meets a first preset condition exists; and
a processor, configured to:
if the first touch operation meets the first preset condition, obtain a to-be-displayed overlay interface of an application program corresponding to the full-screen immersive mode, and determine controls displayed on the to-be-displayed overlay interface;
when determining that a user currently holds the handheld terminal in a single-hand hold mode, determine a display reference point corresponding to the single-hand hold mode;
determine a to-be-moved control from the controls;
adjust a display position of the to-be-moved control, generate a new overlay interface according to an adjusted position of the control; and
replace the to-be-displayed overlay interface with the new overlay interface, wherein on the new overlay interface, a distance between the display position of the to-be-moved control and the display reference point is less than a specified threshold, functions performed by the handheld terminal are the same when the user operates the to-be-moved control before and after the position adjustment, the to-be-displayed overlay interface is superposed and displayed on currently displayed content when being displayed, a distance between the display reference point and a lateral side of the handheld terminal held by the user is less than the specified threshold, and the hold mode comprises left-hand hold or right-hand hold.

23. The handheld terminal according to claim 22, wherein determining, by the processor, the display reference point corresponding to the single-hand hold mode specifically comprises: determining the lateral side of the handheld terminal held by the user, and determining, based on the lateral side, a point on the handheld terminal as the display reference point.

24. The handheld terminal according to claim 23, wherein
determining, by the controller based on the lateral side, the point on the handheld terminal as the display reference point comprises:
obtaining a touch track of the first touch operation;
determining, according to a position of an end point of the touch track relative to a start point, a sliding direction corresponding to the touch track; and
determining, based on the lateral side and the sliding direction, a point on the handheld terminal as the display reference point.

25. The handheld terminal according to claim 22, wherein the input unit is further configured to detect a touch signal, so that the processor determines, according to the touch signal, that the user holds the lateral side of the handheld terminal.

26. The handheld terminal according to claim 22, wherein determining, by the processor, the to-be-moved control from the controls specifically comprises:
detecting a distance between a to-be-displayed position of each of the controls and the display reference point, and when a distance between a to-be-displayed position of any control and the display reference point is greater than the specified threshold, determining that the any control is the to-be-moved control; or
outputting the to-be-displayed overlay interface, detecting whether a second touch operation that meets a second preset condition exists, and if the second touch operation that meets the second preset condition exists, determining the to-be-moved control from the controls according to the second touch operation.

27. The handheld terminal according to claim 22, wherein after replacing the to-be-displayed overlay interface with the new overlay interface, the processor is further configured to:
obtain current display coordinates of a first control on the new overlay interface when the user operates the first control in the to-be-moved control after the position adjustment;
determine, according to the current display coordinates of the first control, corresponding original coordinates of the first control on the to-be-displayed overlay interface; and
invoke a corresponding function according to the original coordinates.

28. The handheld terminal according to claim 22, wherein the processor is further configured to display the to-be-moved control on the new overlay interface in a floating control mode.

29. A computer program product comprising non-transitory computer readable medium having a program recorded thereon; wherein the program makes a computer execute the method of 15.
